(19) United States
(12) Patent Application Publication
(10) Pub. No.: US 2015/0352701 A1
(43) Pub. Date: Dec. 10, 2015

(54) CONTROL MECHANISM CONTROLLABLE OVER SINGLE SHOT AND REPEAT SHOT

(71) Applicant: Yi-Chang Wu, TAICHUNG CITY (TW)

(72) Inventor: Yi-Chang Wu, TAICHUNG CITY (TW)

(21) Appl. No.: 14/298,982

(22) Filed: Jun. 9, 2014

(51) Int. Cl. B25C 1/00

(52) U.S. Cl. CPC B25C 1/008

(57) ABSTRACT

The present invention is a control mechanism controllable over single shot and repeating shot, which is mounted in a discharging device for carrying out single shot and repeating shot modes. The control mechanism comprises a safety pole, a trigger and a sliding hook block. By means of altering the operating order of the trigger and the safety pole, and accompanied by the restoration of the safety pole, the switching between the single shot and the repeating shot modes can be easily accomplished by the discharging device, indeed a product of practicality

### BACKGROUND OF THE INVENTION

1. Field of the Invention

The present invention is a control mechanism, which is mounted in a discharge device for carrying out single shot and repeat shot modes. By means of altering operating order of a trigger and a safety pole, and accompanied by the restoration of the safety pole, the switching between the single shot and the repeat shot can be easily accomplished by the discharge device, indeed a product of practicality.

2. Description of Related Art

To be more in line with the demands of public use, there are already many manufacturers to have developed a switching mechanism of nail hitting modes disposed in the trigger of the nail guns, in order to control the modes of the single nail hitting and the repeat nail hitting.

Currently the control mechanism for the control of the single shot and the repeat shot is mostly disposed at the trigger position. The switching structure of a prior art is located at the trigger body of the nail gun, where the switching structure includes a guide groove, showing the setup type for laterally passing through at least one sidewall of the trigger; two positioning unit, located at two separate places of the guide groove; a lever, placed in the guide groove with a limited position that can be displaced along a predetermined direction of the trigger, having a poke control unit at its one end, and having an accommodating groove which corresponds to the first positioning unit once the lever arrives, and corresponds to the second positioning unit when moving to a second position; a resilient position unit, disposed at the lever, having an elastic engaging portion, which engages and positions the first positioning unit when the lever arrives, and engages and positions the second positioning unit when moving to the second position; an activation piece, having a first end connected to the lever, and a second end extending toward the opposite direction to form an effector; by means of a single-finger pushing to accomplish the position switching between the lever and the actuating piece directly, and the switching between the single nail hitting mode and the repeat nail hitting mode can be achieved.

However, within the lever-type switching structure of the trigger, since the trigger is quite small, not to mention the fact that the lever is mounted on the trigger and the resilient position unit used for the purposes of the displacement and positioning of the lever, and the resilient position unit is a tiny spring and beads, and it calls for complexity, elapsed time and precision in assembly once the spring and beads are mounted in holes of the side wall of the guide groove of the trigger. Hence, the prior art technique is quite inconvenient and cumbersome in mounting, the operation for the nail hitting modes demands a finger to poke the lever for carrying out displacement at a side of the trigger, and such delicate maneuver is quite hard to manipulate for those users with larger fingers.

### SUMMARY OF THE INVENTION

The present invention is a control mechanism, handy for carrying out single shot and repeat shot modes. By means of altering operating order of a trigger and a safety pole, and accompanied by the restoration of the safety pole, the switching between the single shot mode and the repeat shot mode can be easily accomplished by the discharge device, indeed a product of great practicality.

The present invention is a control mechanism which is used to control the single shot and the repeat shot, and is disposed in between a discharge device and a lock of the discharge device, where the control mechanism comprises: a safety pole, movably disposed in the discharge device, and is provided with a hook slot at its one end towards the lock; a trigger, pivoted to the discharge device at its one end, where the trigger pivots on a trigger leaf between the lock and the safety pole; and a slip hook block, slipping in the trigger and corresponding to the end of the safety pole with a hook slot; accordingly, the end of the safety pole with the hook slot is displaced first, followed by the pressing of the trigger, where the engagement of the slip hook block and the hook slot is the single shot mode of the discharge device; on the other hand, once the trigger is pressed first, where the state that the end of the safety pole with the hook slot is displaced later and proceeded to push and prop the slip hook block and the trigger leaf is the repeat shot mode of the discharge device.

The above control mechanism for the control of the single shot and the repeat shot further includes a guide tube, where the guide tube is disposed in the discharge device and near the lock, and the guide tube is provided with a shift slot while one end of the safety pole passes through the shift slot of the guide tube. The middle portion of the safety pole is protruded to form a halt prop, and the safety pole passes through the shift slot of the guide tube and moves towards the lock, where the direction of the moving is limited by the engagement of the halt prop and a position limit block.

The above control mechanism is able to control the single shot and the repeat shot, where the trigger is provided with a void at its one side, and the end of the safety pole with the hook slot is available to pass through the void. The trigger is provided with a slip hole at its one end which penetrates through the trigger, where the slip hole joins the void at its one end, and the slip hook block slips in the slip hole and is exposed to outside with a part of it. The trigger further includes a cover for blocking the slip hole at the end opposite to joining with the void, and a spring disposed in the slip hole and between the cover and the slip hook block which prop against one with the other. There are two location holes disposed at the cover, and the trigger is provided with two undercut blocks at the end face with the slip hole which engage with the location holes respectively.

### BRIEF DESCRIPTION OF THE DRAWINGS

FIG. 1 is a perspective view of the discharge device of a preferred embodiment of the present invention;

FIG. 2 is a three-dimensional exploded diagram of a preferred embodiment of the present invention;

FIG. 3 is a schematic diagram prior to the action of the repeat shot mode of a preferred embodiment of the present invention; and

FIG. 4 is a schematic diagram of pressing the trigger in the repeat shot mode of a preferred embodiment of the present invention;

FIG. 5 is a schematic diagram of the displacement of the safety pole after the trigger is pressed in the repeat shot mode of a preferred embodiment of the present invention;

FIG. 6 is a schematic diagram of the pushing of the safety pole to the slip hook block and the trigger leaf in the repeat shot mode of a preferred embodiment of the present invention;

FIG. 7 is an enlarged diagram of a portion of FIG. 6;

FIG. 8 is a schematic diagram prior to the action of the single shot mode of a preferred embodiment of the present invention;

FIG. 9 is a schematic diagram of the displacement of the safety pole of the single shot mode of a preferred embodiment of the present invention;

FIG. 10 shows the mutual clamping of the slip hook block and the safety pole after the trigger is pressed in the single shot mode of a preferred embodiment of the present invention; and

FIG. 11 is an enlarged diagram of a portion of FIG. 10.

### DETAILED DESCRIPTION OF THE INVENTION

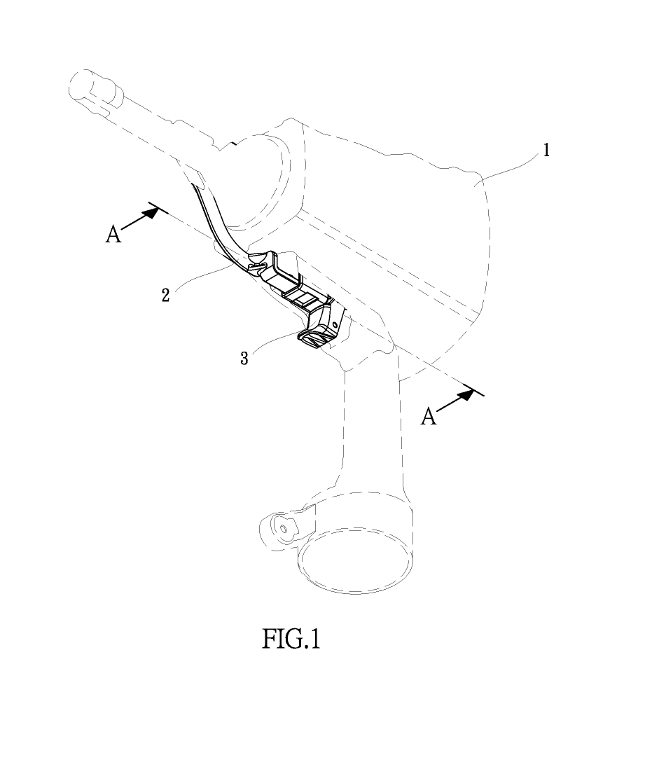

To achieve the foregoing objective and function, a preferred embodiment of the present invention is cited with a reference to FIGS. 1-3, where the present invention is a control mechanism that is able to control single shot and repeat shot, and is disposed in between a discharge device 1 and a lock 11 of the discharge device 1, and the control mechanism comprises: a safety pole 2, movably disposed in the discharge device 1, and is provided with a hook slot 21 at its one end towards the lock 11; a trigger 3, pivoted to the discharge device 1 at its one end, where the trigger 3 pivots on a trigger leaf 31 between the lock 11 and the safety pole 2; and a slip hook block 4, slipping in the trigger 3 and corresponding to the end of the safety pole 2 with a hook slot 21; accordingly, the end of the safety pole 2 with the hook slot 21 is displaced first, followed by the pressing of the trigger 3, where the engagement of the slip hook block 4 and the hook slot 21 is the single shot mode of the discharge device 1; on the other hand, once the trigger 3 is pressed first, where the state that the end of the safety pole 2 with the hook slot 21 is displaced later and proceeded to push and prop the slip hook block 4 and the trigger leaf 31 is the repeat shot mode of the discharge device 1.

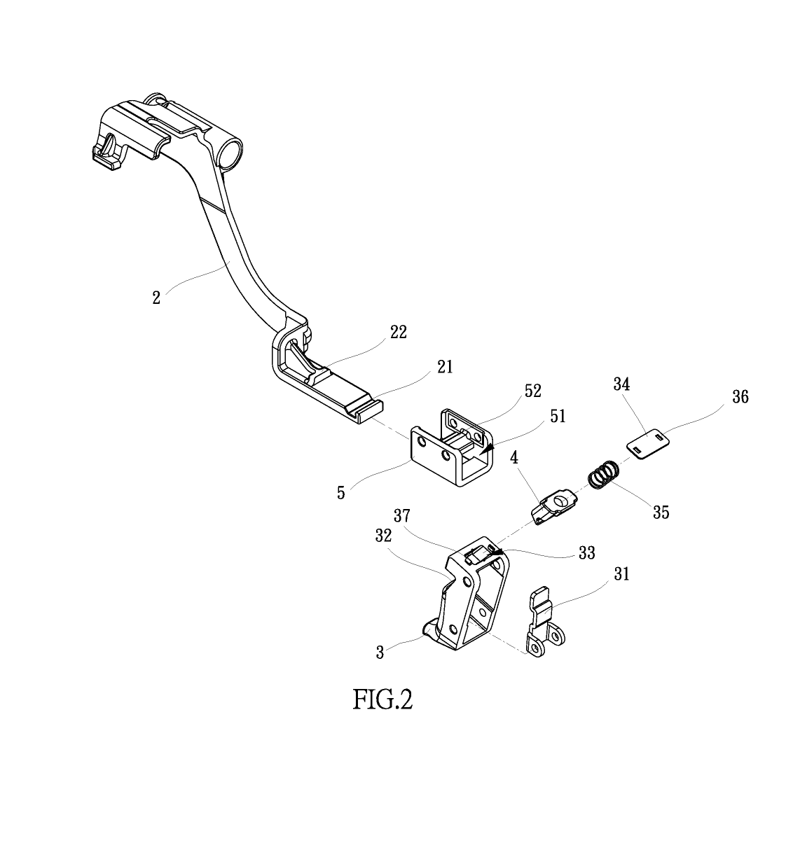

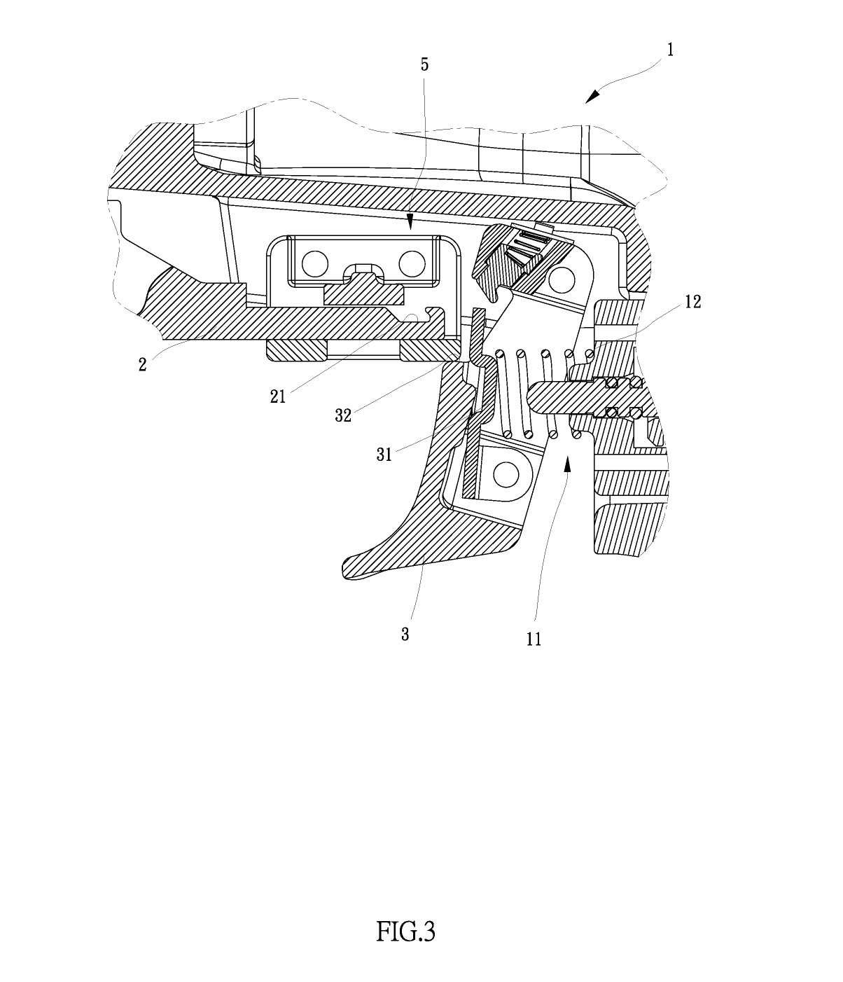

With reference to FIGS. 2-3, the control mechanism for the control of the single shot and the repeat shot further includes a guide tube 5, where the guide tube 5 is disposed in the discharge device 1 and near the lock 11, and the guide tube 5 is provided with a shift slot 51 while one end of the safety pole 2 passes through the shift slot 51 of the guide tube 5. The shift slot 51 of the guide tube 5 is provided with a position limit block 52. The middle portion of the safety pole 2 is protruded to form a halt prop 22, and the safety pole 2 passes through the shift slot 51 of the guide tube 5 and moves towards the lock 11, where the direction of the moving is limited by the engagement of the halt prop 22 and the position limit block 52.

With reference to FIGS. 2-3, the above control mechanism is provided with a void 32 at one side of the trigger 3, and the end of the safety pole 2 with the hook slot 21 is available to pass through the void 32. The void 32 corresponds to the opposite position at which a trigger leaf 31 is pivoted. The trigger 3 is provided with a slip hole 33 at its one end which penetrates through the trigger 3, where the slip hole 33 joins the void 32 at its one end, and the slip hook block 4 slips in the slip hole 33 and is exposed to outside with a part of it. The trigger 3 further includes a cover 34 for blocking the slip hole 33 at the end opposite to joining with the void 32, and a spring 35 disposed in the slip hole 33 and between the cover 34 and the slip hook block 4 which prop against one with the other. There are two location holes 36 disposed at the cover 34, and the trigger 3 is provided with two undercut blocks 37 at the end face with the slip hole 33 which engage with the location holes 36 respectively.

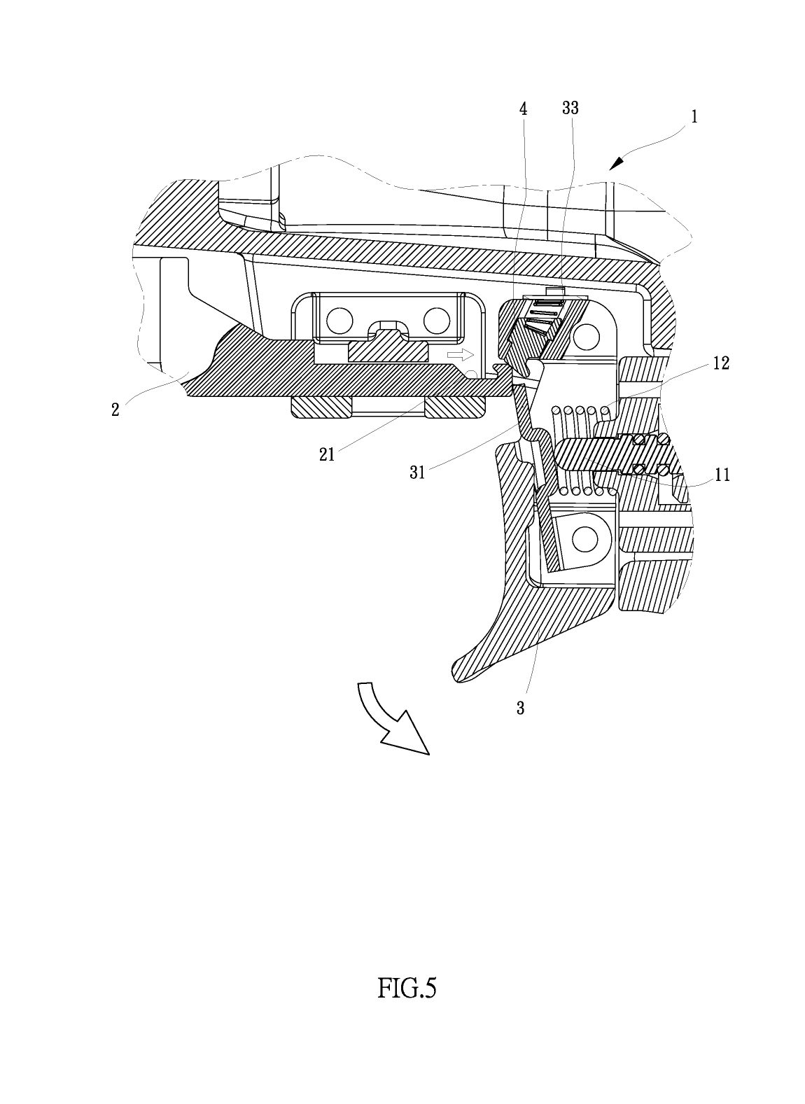

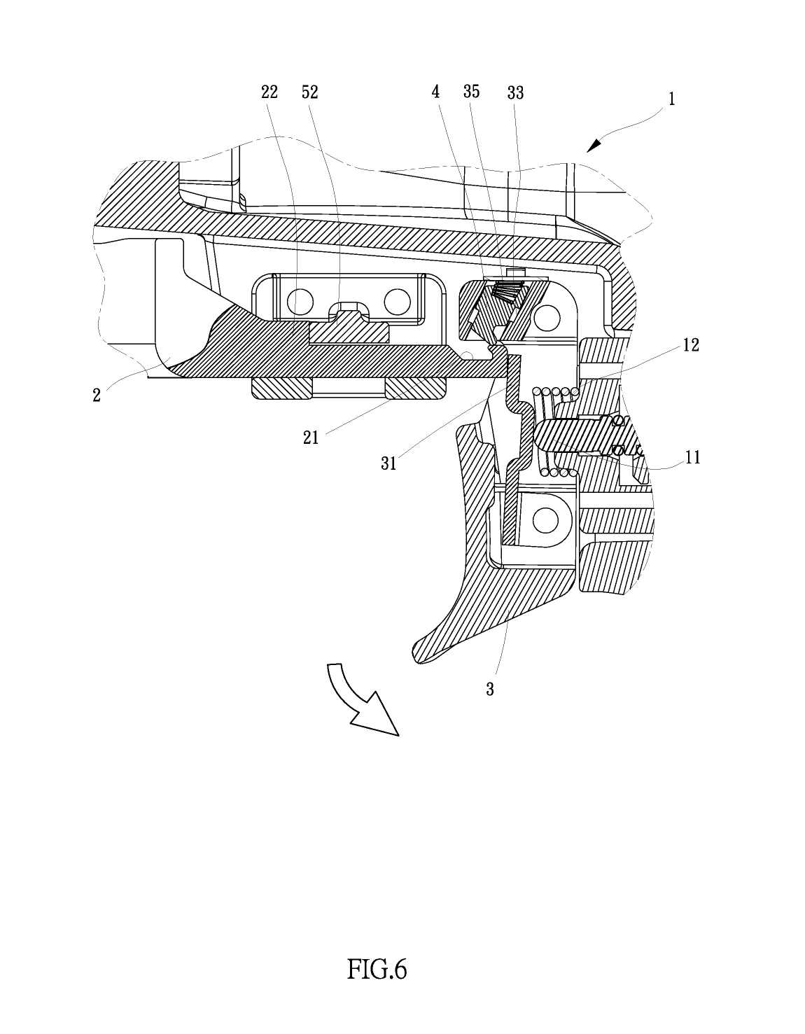

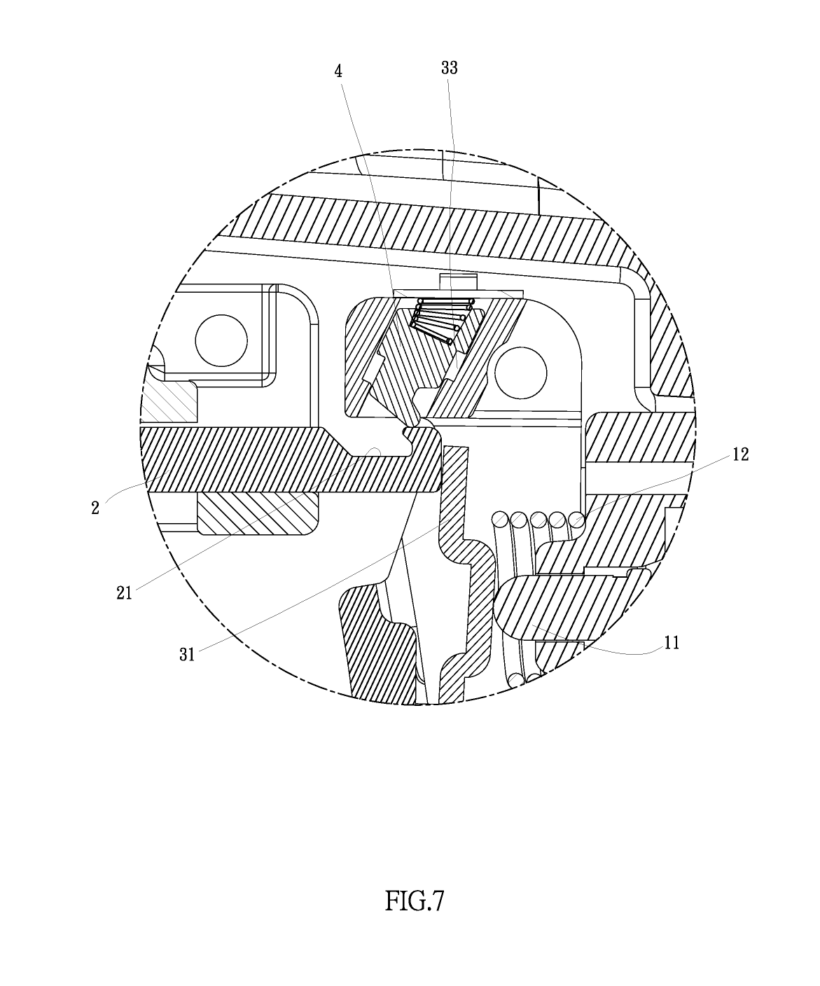

The manipulation of the control mechanism for the control of the single shot and the repeat shot is shown in FIGS. 3-7, which are the schematic diagrams of the manipulation of the repeat mode for the discharge device of this invention.

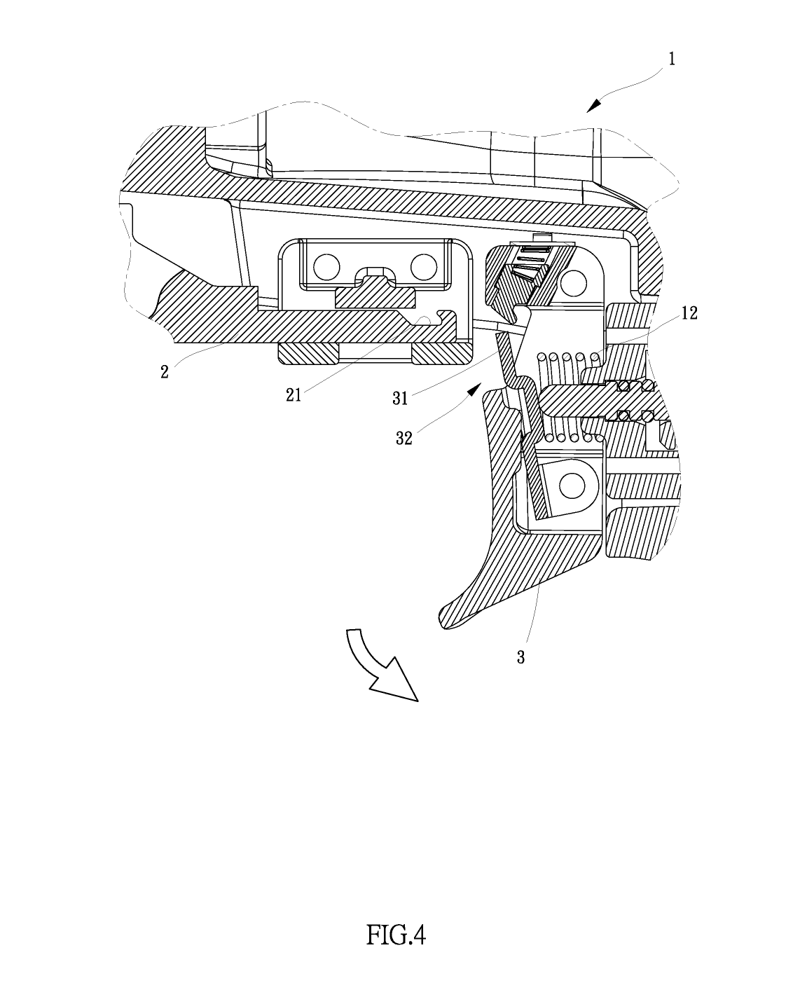

The inactive state of the discharge device 1 is shown in FIG. 3. Through a switching spring 12 pushing on the trigger leaf 31, the trigger leaf 31 and the trigger 3 is heading towards the guide tube 5, and the inner bottom edge of the void 32 of the trigger 3 props against the bottom edge of the guide tube 5. Reference to FIG. 4, the trigger 3 is pulled first and the safety pole 2 is pressed to the face of a work piece (not shown in the figure) and moves towards the direction of the lock 11. The end of the safety pole 2 with the hook slot 21 passes through the void 32, and props against the slip hook block 4 and the trigger leaf 31 to swing so that the bottom edge of the slip hook block 4 is pushed by the safety pole 2 and is shrunk in the slip hole 33. Meanwhile, the slip hook block 4 presses the spring to empower its potential energy, and the trigger leaf 31 presses the lock spring 12 and pushes the lock 11 inward, which enables the lock 11 to engage the nail hitting of the discharge device 1. Once the discharge device 1 is lifted to restore the safety pole 2, the pressing to the face of the work piece is repeated, which keeps the pressing on the trigger 3 by the user and the lifting the discharge device 1 and the pressing the work piece that are required by the above displacement of the safety pole 2, and controls the discharge device 1 in the repeat mode (successively pressing the trigger 3 to enable the move of the safety pole 2 to push the trigger leaf 31 for engaging the nail hitting). Until the release of the trigger 3, the lock spring 12 is not pressed any more, and the resilient force of the lock spring 12 pushes the trigger leaf 31 to swing towards the guide tube 5, which helps the trigger leaf to move apart from the lock 11 and release the state of constant pressing on the lock 11 by the trigger leaf 31, to restore the discharge device 1 back to the inactive state.

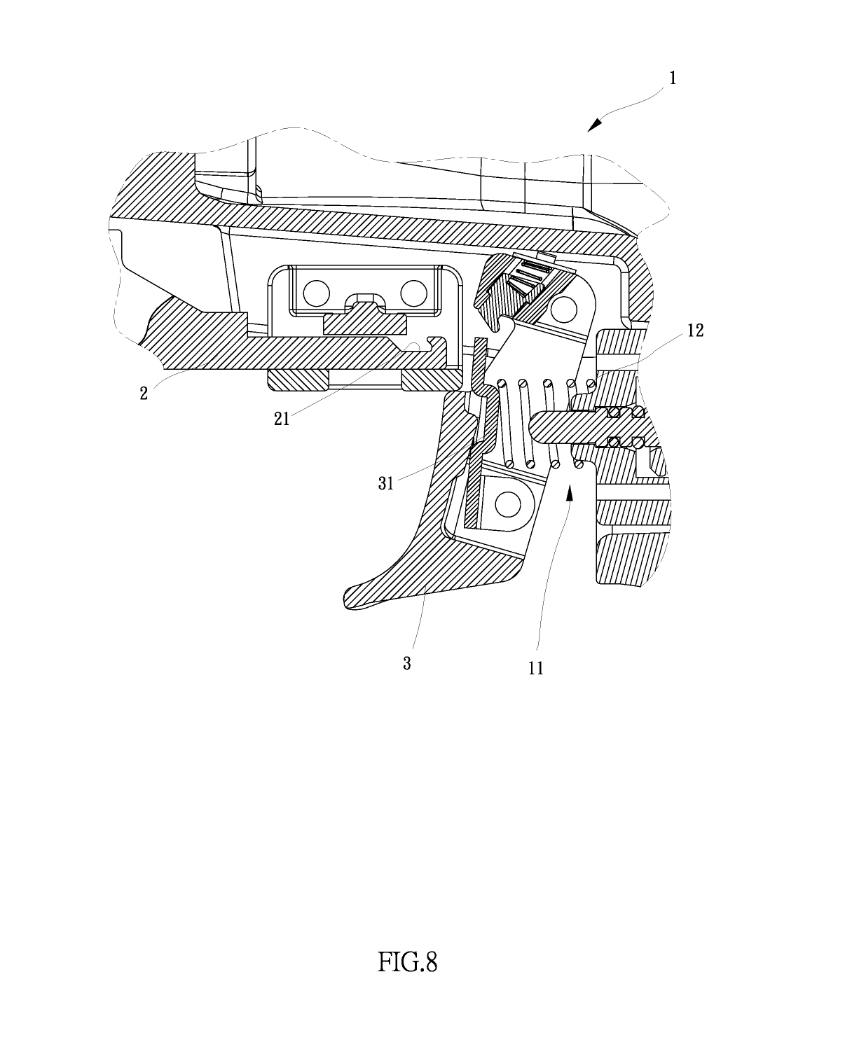

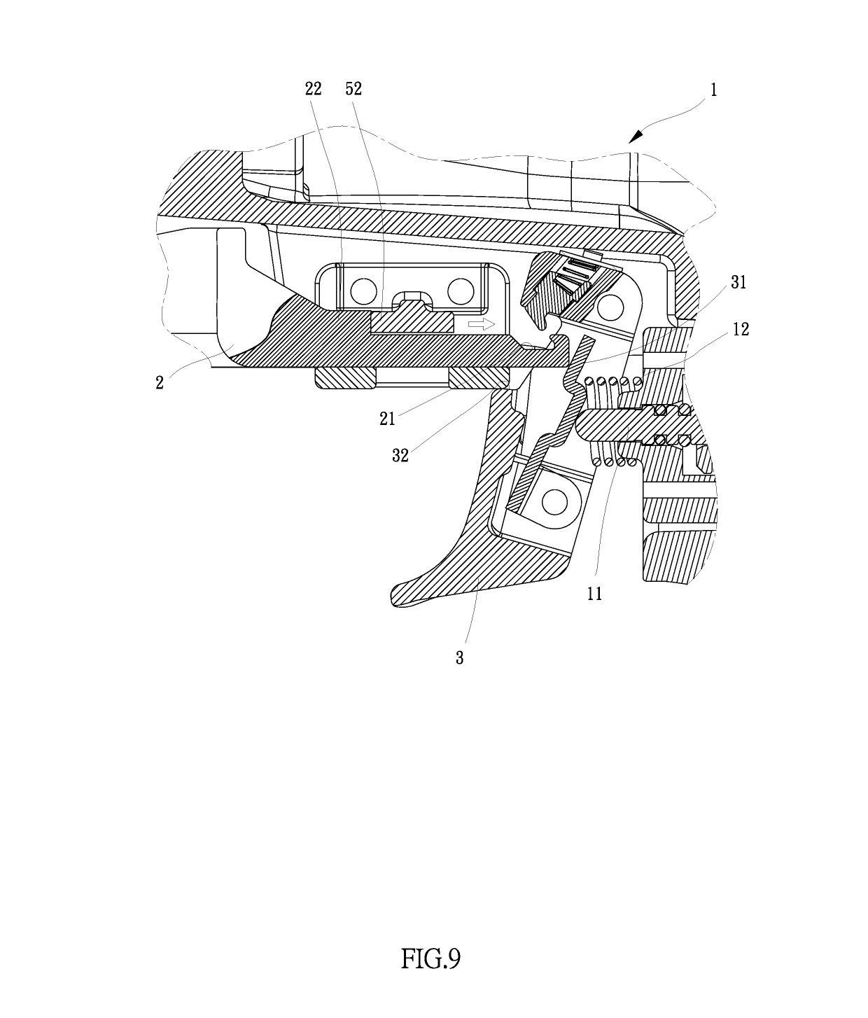

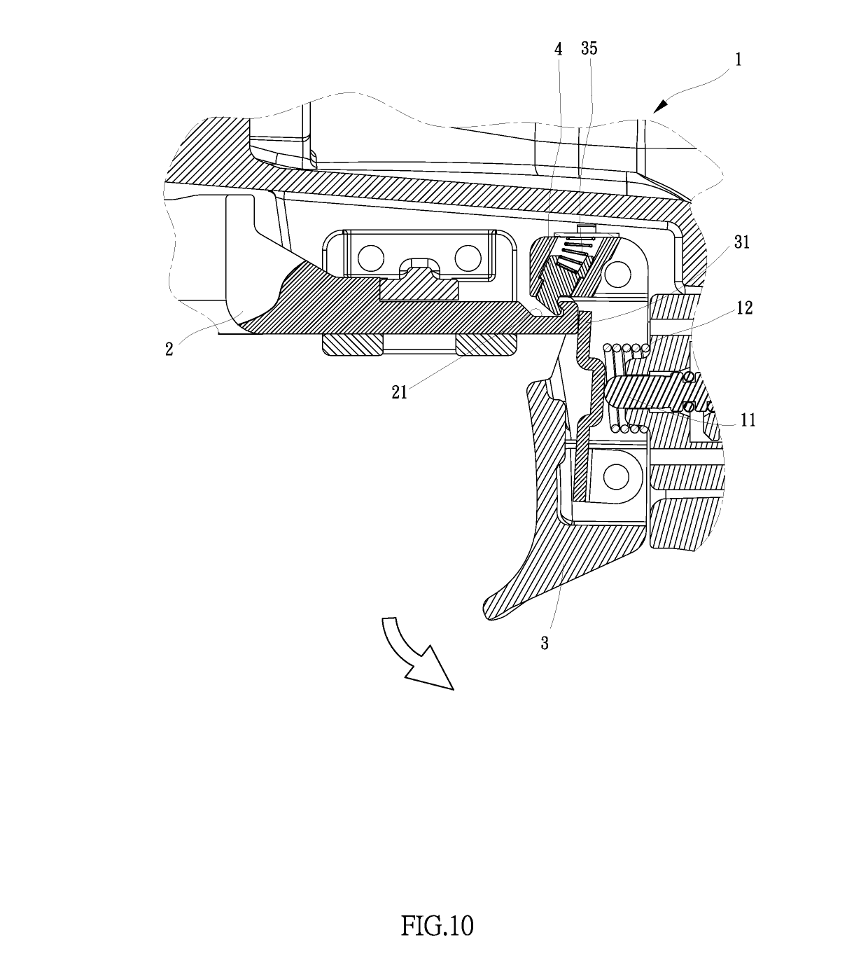

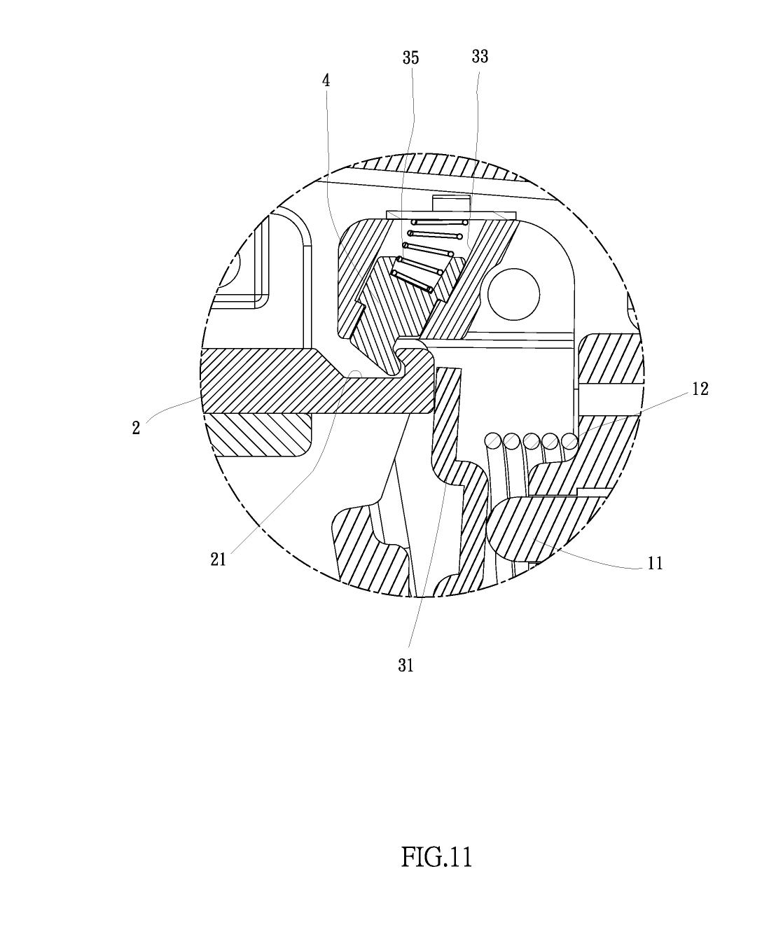

References to FIGS. 8-11, these figures are the schematic diagrams of the manipulation of the single mode for the discharge device of this invention. As shown in FIG. 9, firstly, a user manages the safety pole 2 to move towards the lock 11 (that is, the safety pole 2 is pressed to the face of a work piece (not shown in the figure) and moves towards the direction of the lock 11), and the end of the safety pole 2 with the hook slot 21 passes through the void 32, which makes the safety pole 2 to prop against the trigger leaf 31 to swing and compress the lock spring 12 moderately. As shown in FIG. 10, the trigger 3 is pulled by the user which makes the trigger 3 to swing towards the lock 11 so that the trigger leaf 31 in the trigger 3 props against the lock 11 and compresses the lock spring 12 to empower its potential energy, which enables the lock 11 to engage the nail hitting of the discharge device 1. Since the hook slot 21 of the safety pole 2 is located at the bottom of the slip hook block 4, with the swing of the trigger 3 towards the lock 11, the slip hook block 4 and the hook slot 21 of the safety pole 2 are then clamped one with the other. Once the trigger 3 is released by the user to enable the lock spring 12 to prop against the trigger leaf 31, to let the trigger 3 swinging apart from the lock 11, the hook slot 21 of the safety pole 2 keeps to be propped against by the slip hook block 4, which avoids the safety pole 2 from moving back to the original position. And the above description limits the discharge device 1 to be in single shot of the nail hitting, which means that the next single hitting of nail simply needs a pulling on the trigger 3 again.

It is worth mentioning that a deadlock point for the safety pole 2 of this invention to move towards the lock 11 is found at the restraint of the halt prop 22 of the safety pole 2 by the position limit block 52 of the guide tube 5, with which the safety pole 2 is able to be refrained from excessive displacement.

The foregoing descriptions are merely the exemplified embodiments of the present invention, where the scope of the claim of the present invention is not intended to be limited by the embodiments. Any equivalent embodiments or modifications without departing from the spirit and scope of the present invention are therefore intended to be embraced.

The disclosed structure of the invention had not appeared in the prior art, which is no doubt to possess novelty, and this invention features efficacy better than the prior structure which is construed to be a creative invention, thereby filing the present application herein subject to the patent law, which may obtain a patent thereof.

What is claimed is:

1. A control mechanism controllable over single shot and repeat shot, disposed in between a discharge device and a lock of the discharge device, the control mechanism comprising:
a safety pole, movably disposed in the discharge device, and being provided with a hook slot at one end thereof towards the lock;
a trigger, pivoted on the discharge device at one end thereof, where a trigger leaf pivots on inside of said trigger between the lock and said safety pole; and
a slip hook block, moveably disposed in said trigger and in accordance with an end of said safety pole with a hook slot,
the end of said safety pole with the hook slot being displaced first, followed by a pressing of said trigger, where the engagement of said slip hook block and the hook slot is a single shot mode of the discharge device; on the other hand, once said trigger is pressed first, where the end of said safety pole with the hook slot displaces later and proceeds to push and prop against said slip hook block and the trigger leaf, which is a repeat shot mode of the discharge device.

2. The control mechanism controllable over single shot and repeat shot as claimed in claim 1 further comprises a guide tube, where the guide tube is disposed in the discharge device and near the lock and the guide tube is provided with a shift slot while one end of said safety pole passes through the shift slot of the guide tube.

3. The control mechanism controllable over single shot and repeat shot as claimed in claim 2, wherein the shift slot of the guide tube is provided with a position limit block and a middle portion of said safety pole is protruded to form a halt prop, and said safety pole passing through the shift slot of the guide tube and moving towards the lock, where the direction of the moving is limited by the engagement of the halt prop and the position limit block.

4. The control mechanism controllable over single shot and repeat shot as claimed in claim 1, wherein said trigger is provided with a void at one side thereof and the end of said safety pole with the hook slot is available to pass through the void, said trigger being provided with a slip hole at one end thereof which penetrates through said trigger, where the slip hole joins the void at one end thereof and said slip hook block is movably disposed in the slip hole and with a part thereof exposed to outside of the void.

5. The control mechanism controllable over single shot and repeat shot as claimed in claim 4 further comprises a cover for blocking the slip hole at an end opposite to a joining with the void, and a spring disposed in the slip hole and between the cover and said slip hook block which prop against one with the other.

6. The control mechanism controllable over single shot and repeat shot as claimed in claim 5, wherein two location holes disposed at the cover separately, and said trigger being provided with two undercut blocks at an end face with the slip hole which engage with the location holes respectively.
